(19) United States
(12) Patent Application Publication
(10) Pub. No.: US 2006/0256126 A1
(43) Pub. Date: Nov. 16, 2006

(54) Display apparatuses and methods for display parameter adjustment contingent upon display content

(75) Inventor: Chang-Heng Lin, Taoyuan City (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/430,008

(22) Filed: May 9, 2006

(30) Foreign Application Priority Data
May 11, 2005 (TW) 94115186

(51) Int. Cl. G09G 5/02

(52) U.S. Cl. 345/589

(57) ABSTRACT

A method for display parameter adjustment contingent upon display content. Pixel data in a picture is acquired. An edge pixel number is calculated using the received pixel data in the picture. It is determined whether the picture is a text-based picture or a graphic-based picture. The edge pixel number represents how many pixels have pixel data with dissimilar color or luminance from adjacent pixels.

### BACKGROUND

The present invention relates to display apparatuses, and more particularly, to display apparatuses and methods capable of display parameter adjustment contingent upon display content.

Two types of pictures, text-based pictures and graphic-based pictures, are typically displayed for various applications. For example, when word processing applications or Internet browsing applications are performed, the displayed picture contains text, and otherwise, when multimedia files or games are played, the displayed picture contains various graphics. The text-based pictures are typically motionless and the background thereof is plain while the content thereof such as icons, characters, symbols or others, are distinct and sharp in contrast to the background. Due to the nature of liquid crystal panels, the display quality suffers in color or motion rendering when movies or games are played on liquid crystal display (LCD) monitors. Comparing the nature of content between text-based pictures and graphic-based pictures, the former is plain in color, and characters and icons are clear-cut while the latter is smooth and vivid in color.

### SUMMARY

Methods for display parameter adjustment contingent upon display content, performed by a display apparatus, are provided. An exemplary method acquires pixel data in a picture, calculates an edge pixel number using the received pixel data in the picture and determines whether the picture is a text-based picture or a graphic-based picture. The edge pixel number represents how many pixels have pixel data with dissimilar color or luminance from adjacent pixels.

In an aspect, the pixel data in the picture may be luminance data. The method may further comprise converting RGB data into the luminance data.

In an aspect, the method may further comprise outputting a display adjustment signal when the determination result for the picture does not correspond to the current display environment, enabling the display apparatus to adjust a display parameter contingent upon the display adjustment signal. The step of determining whether the picture is a text-based picture or a graphic-based picture may further comprise determining the picture is text-based picture when the edge pixel number exceeds a quantity threshold, and determining that the picture is a graphic-based picture when the edge pixel number is lower the quantity threshold. Multiple fixed-size subsets may be extracted from the picture, any two of the subsets are mutually independent or partially overlapping, and pixel data in each subset may be represented as:

$${D}_{c \times c} = [ \begin{matrix}{D}_{1 , 1} & {D}_{1 , 2} & ⋯ & {D}_{1 , c - 1} & {D}_{1 , c} \\ {D}_{2 , 1} & {D}_{2 , 2} & ⋯ & {D}_{2 , c - 1} & {D}_{2 , c} \\ ⋮ & ⋮ & ⋮ & ⋮ & ⋮ \\ {D}_{c - 1 , 1} & {D}_{c - 1 , 2} & ⋯ & {D}_{c - 1 , c - 1} & {D}_{c - 1 , c} \\ {D}_{c , 1} & {D}_{c , 2} & ⋯ & {D}_{c , c - 1} & {D}_{c , c}\end{matrix} ] ,$$

where c represents a predetermined constant. The step of calculating the edge pixel number may further comprise acquiring a pixel difference by calculating the pixel data in each subset with a mask matrix, determining whether the pixel difference exceeds a difference threshold, and, if the pixel difference exceeds the difference threshold, determining that the central pixel in the subset is an edge pixel, and accordingly updating the edge pixel number. The mask matrix may be represented as:

$${M}_{c \times c} = [ \begin{matrix}{M}_{1 , 1} & {M}_{1 , 2} & ⋯ & {M}_{1 , c - 1} & {M}_{1 , c} \\ {M}_{2 , 1} & {M}_{2 , 2} & ⋯ & {M}_{2 , c - 1} & {M}_{2 , c} \\ ⋮ & ⋮ & ⋮ & ⋮ & ⋮ \\ {M}_{c - 1 , 1} & {M}_{c - 1 , 2} & ⋯ & {M}_{c - 1 , c - 1} & {M}_{c - 1 , c} \\ {M}_{c , 1} & {M}_{c , 2} & ⋯ & {M}_{c , c - 1} & {M}_{c , c}\end{matrix} ] ,$$

and
the pixel difference may be calculated by

$${Diff}_{d} = {\sum }_{i = 1 toc ; j = 1 toc} D ( i , j ) * M ( i , j ) ,$$

where d represents the central pixel in each subset. c may equal 3. The mask matrix may be represented as:

$${M}_{3 \times 3} = [ \begin{matrix}0 & 1 & 0 \\ 1 & - 4 & 1 \\ 0 & 1 & 0\end{matrix} ] .$$

The display parameter may be color, contrast or liquid crystal response time. The step of outputting a display adjustment signal may further comprise acquiring an accumulated picture number corresponding to the determined result of the picture, determining whether the accumulated picture number exceeds an accumulation threshold, and outputting the display adjustment signal when the accumulated picture number exceeds the accumulation threshold.

Display apparatuses for display parameter adjustment contingent upon display content are provided. An embodiment of a display apparatus comprises an edge detection module. The edge detection module acquires pixel data in a picture, calculates an edge pixel number using the received pixel data in the picture and determines whether the picture is a text-based picture or a graphic-based picture. The edge pixel number represents how many pixels have pixel data with dissimilar color or luminance from adjacent pixels.

In an aspect, the pixel data in the picture may be luminance data. The display apparatus may further comprise converting RGB data into the luminance data.

In an aspect, the display apparatus may further comprise a status modification module coupling to the edge detection module and outputting a display adjustment signal when the determination result for the picture does not correspond to the current display environment, enabling adjustment of a display parameter contingent upon the display adjustment signal. The edge detection module may further determine that the picture is a text-based picture when the edge pixel number exceeds a quantity threshold, and determine that the picture is a graphic-based picture when the edge pixel number is lower the quantity threshold. Multiple fixed-size subsets may be extracted from the picture, any two of the subsets are mutually independent or partially overlapping, and pixel data in each subset may be represented as:

$${D}_{c \times c} = [ \begin{matrix}{D}_{1 , 1} & {D}_{1 , 2} & ⋯ & {D}_{1 , c - 1} & {D}_{1 , c} \\ {D}_{2 , 1} & {D}_{2 , 2} & ⋯ & {D}_{2 , c - 1} & {D}_{2 , c} \\ ⋮ & ⋮ & ⋮ & ⋮ & ⋮ \\ {D}_{c - 1 , 1} & {D}_{c - 1 , 2} & ⋯ & {D}_{c - 1 , c - 1} & {D}_{c - 1 , c} \\ {D}_{c , 1} & {D}_{c , 2} & ⋯ & {D}_{c , c - 1} & {D}_{c , c}\end{matrix} ] ,$$

where c represents a predetermined constant. The edge detection module may further acquire a pixel difference by calculating the pixel data in each subset with a mask matrix, determine whether the pixel difference exceeds a difference threshold, and, if the pixel difference exceeds the difference threshold, determine that the central pixel in the subset is an edge pixel, and accordingly update the edge pixel number. The mask matrix may be represented as:

$${M}_{c \times c} = [ \begin{matrix}{M}_{1 , 1} & {M}_{1 , 2} & ⋯ & {M}_{1 , c - 1} & {M}_{1 , c} \\ {M}_{2 , 1} & {M}_{2 , 2} & ⋯ & {M}_{2 , c - 1} & {M}_{2 , c} \\ ⋮ & ⋮ & ⋮ & ⋮ & ⋮ \\ {M}_{c - 1 , 1} & {M}_{c - 1 , 2} & ⋯ & {M}_{c - 1 , c - 1} & {M}_{c - 1 , c} \\ {M}_{c , 1} & {M}_{c , 2} & ⋯ & {M}_{c , c - 1} & {M}_{c , c}\end{matrix} ] ,$$

and
the pixel difference may be calculated by

$${Diff}_{d} = {\sum }_{i = 1 toc ; j = 1 toc} D ( i , j ) * M ( i , j ) ,$$

where d represents the central pixel in each subset. c may equal 3. The mask matrix may be represented as:

$${M}_{3 \times 3} = [ \begin{matrix}0 & 1 & 0 \\ 1 & - 4 & 1 \\ 0 & 1 & 0\end{matrix} ] .$$

The display parameter may be color, contrast or liquid crystal response time. The status modification module may further acquire an accumulated picture number corresponding to the determined result of the picture, determine whether the accumulated picture number exceeds an accumulation threshold, and output the display adjustment signal when the accumulated picture number exceeds the accumulation threshold.

The display apparatus may be a Liquid Crystal Display (LCD), Plasma Display Panel (PDP) or Organic Light-Emitting Diode (OLED) apparatus. The pixel data in the picture may be RGB data.

### DESCRIPTION OF THE DRAWINGS

The invention will become more fully understood by referring to the following detailed description of embodiments with reference to the accompanying drawings, wherein:

FIG. 1 is a diagram of system architecture of an embodiment of a Liquid Crystal Display (LCD) apparatus;

FIG. 2 is the architecture of an embodiment of a display adjustment system in a scalar IC;

FIG. 3 is a diagram of an exemplary picture;

FIG. 4 is a diagram of an embodiment of a hysteresis mechanism for environment adjustment;

FIG. 5 is a flowchart of an embodiment of a method for display adjustment contingent upon picture content.

### DETAILED DESCRIPTION

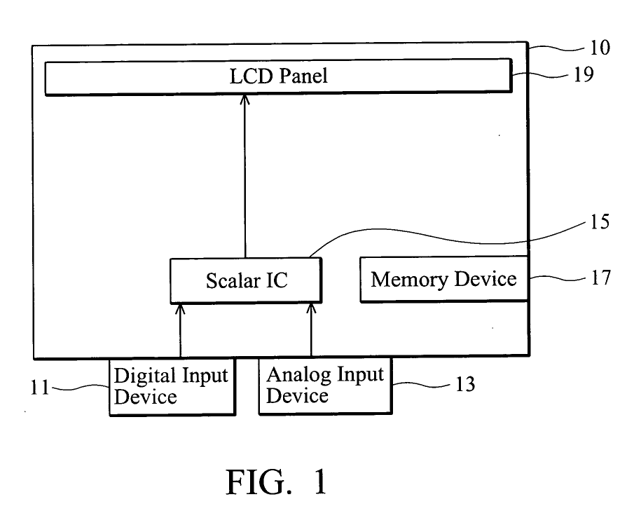

FIG. 1 is a diagram of system architecture of an embodiment of Liquid Crystal Display (LCD) apparatus. A LCD apparatus 10 comprises a digital input device 11, an analog input device 13, a scalar IC 15, a memory device 17 and a LCD panel 19. Moreover, those skilled in the art will understand that some embodiments may be practiced with other display configurations, including Cathode Ray Tube (CRT), Plasma Display Panel (PDP), Organic Light-Emitting Diode (OLED) displays, and the like. The memory device 17, such as random access memory (RAM), read-only memory (ROM), flash ROM, and the like, stores program modules executed by the scalar IC 15 to perform display parameter adjustment. The scalar IC 15 receives R, G, B, Hsync and Vsync signals via the digital input device 11 or analog input device 13, and accordingly controls the LCD panel to display specific pictures. R, G, B signals provide color information for all pixels in a picture.

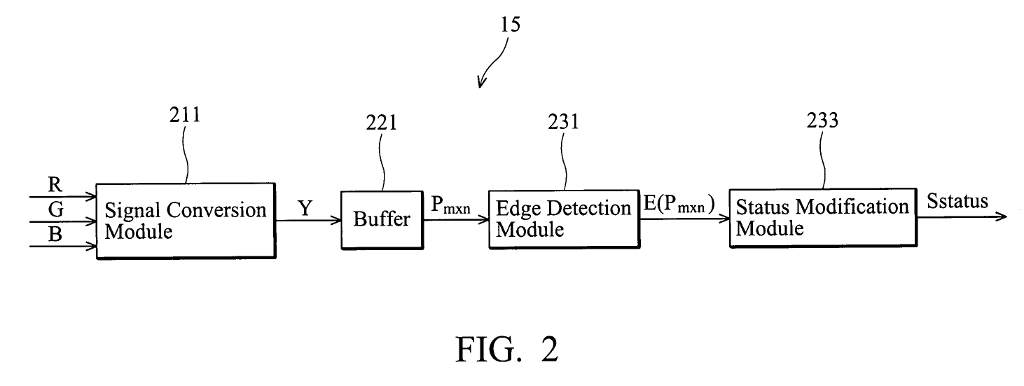

FIG. 2 is the architecture of an embodiment of a display adjustment system in the scalar IC 15, comprising a signal conversion module 211, a buffer 221, an edge detection module 231 and a status modification module 233. The signal conversion module 211 receives RGB data of pixels in pictures and converts RGB data to YCrCb data containing luminance (Y) and chrominance data (Cr and Cb). Such conversion reduces design complexity of the edge detection module 231. Formulae 1 to 3 convert RGB data into YCrCb data:
Y=0.299(R−G)+G+0.114(B−G); (1)
Cb=0.564(B−Y); and (2)
Cr=0.713(R−Y) (3)
where R represents red-scale value of RGB data (ranging from 0 to 255), G represents green-scale value of RGB data (ranging from 0 to 255) and B represents blue-scale value of RGB data (ranging from 0 to 255). The signal conversion module 211 subsequently transmits the converted luminance data to the buffer 221.

In order to improve detection efficiency, the buffer 221 acquires and transmits a portion of luminance data Y_{m×c} for the region P_{m×c} in a picture, where m represents a width of a picture and c represents a constant value (preferably is 3), to the edge detection module 231. The edge detection module 231 determines whether each non-border pixel in the portion of region P_{m×c} is an edge pixel. Edge pixels are pixels have pixel data with dissimilar color or luminance from adjacent pixels. The edge detection module 231 repeatedly acquires luminance data Y′_{c×c} for a subset P′_{c×c} in the region P_{m×c}, operates the acquired data with a predefined mask matrix M_{c×c} to calculate a luminance difference Diffₚ, and determines whether the luminance difference exceeds a threshold, and, if so, the central pixel in the subset P′_{c×c} is an edge pixel, and otherwise, is an non-edge pixel. Formula 4 shows luminance data Y′_{c×c} for a subset P′_{c×c}:

$${Y}_{c \times c}^{′} = [ \begin{matrix}{Y}_{1 , 1} & {Y}_{1 , 2} & ⋯ & {Y}_{1 , c - 1} & {Y}_{1 , c} \\ {Y}_{2 , 1} & {Y}_{2 , 2} & ⋯ & {Y}_{2 , c - 1} & {Y}_{2 , c} \\ ⋮ & ⋮ & ⋮ & ⋮ & ⋮ \\ {Y}_{c - 1 , 1} & {Y}_{c - 1 , 2} & ⋯ & {Y}_{c - 1 , c - 1} & {Y}_{c - 1 , c} \\ {Y}_{c , 1} & {Y}_{c , 2} & ⋯ & {Y}_{c , c - 1} & {Y}_{c , c}\end{matrix} ] , \qquad ( 4 )$$

where Y_{1, 1} to Y_{c, c} represent luminance data. Formula 5 shows a mask matrix M_{c×c}:

$${M}_{c \times c} = [ \begin{matrix}{M}_{1 , 1} & {M}_{1 , 2} & ⋯ & {M}_{1 , c - 1} & {M}_{1 , c} \\ {M}_{2 , 1} & {M}_{2 , 2} & ⋯ & {M}_{2 , c - 1} & {M}_{2 , c} \\ ⋮ & ⋮ & ⋮ & ⋮ & ⋮ \\ {M}_{c - 1 , 1} & {M}_{c - 1 , 2} & ⋯ & {M}_{c - 1 , c - 1} & {M}_{c - 1 , c} \\ {M}_{c , 1} & {M}_{c , 2} & ⋯ & {M}_{c , c - 1} & {M}_{c , c}\end{matrix} ] , \qquad ( 5 )$$

where M_{1, 1} to M_{c, c} represent weighted values. Formula 6 calculates a luminance difference Diffₚ:

$${Diff}_{p} = {\sum }_{i = 1 toc ; j = 1 toc} Y ( i , j ) * M ( i , j ) , \qquad ( 6 )$$

where Y (i, j) represents luminance data and M (i, j) represents a weighted value. For example, when c=3 and the edge detection module 231 is configured to detect only left, right, upper and underlying pixels adjacent to a central pixel, formula 7 shows a mask matrix M_{3×3}:

$${M}_{3 ⨯ 3} = [ \begin{matrix}0 & 1 & 0 \\ 1 & - 4 & 1 \\ 0 & 1 & 0\end{matrix} ] . \qquad ( 7 )$$

When c=3 and the edge detection module 231 is configured to detect all pixels adjacent to a central pixel, formula 8 shows a mask matrix M_{3×3}:

$${M}_{3 ⨯ 3} [ \begin{matrix}1 & 1 & 1 \\ 1 & - 8 & 1 \\ 1 & 1 & 1\end{matrix} ] . \qquad ( 8 )$$

Note that the edge detection module 231 repeatedly detects (m−2) times to complete detections for all non-border pixels in the region P_{m×c}. When the entire region P_{m×c} is processed completely, the edge detection module 231 acquires another region in the same picture from the buffer 221. If resolution of a picture is m×n, the edge detection module 231 repeatedly detects (m−2)×(n−2) times. When the entire picture is processed completely, the edge detection module 231 calculates an edge pixel number E (P_{m×n}) for this picture and determines whether the edge pixel number exceeds a predetermined threshold, and, if so, determines that the picture is a text-based picture, and otherwise, determines that the picture is a graphic-based picture. The edge detection module 231 transmits a determination result to the status modification module 233. The edge detection module 231 acquires luminance data Y_{m×c} for a region P_{m×c} in the next picture from the buffer 221 to perform another detection process for the next picture.

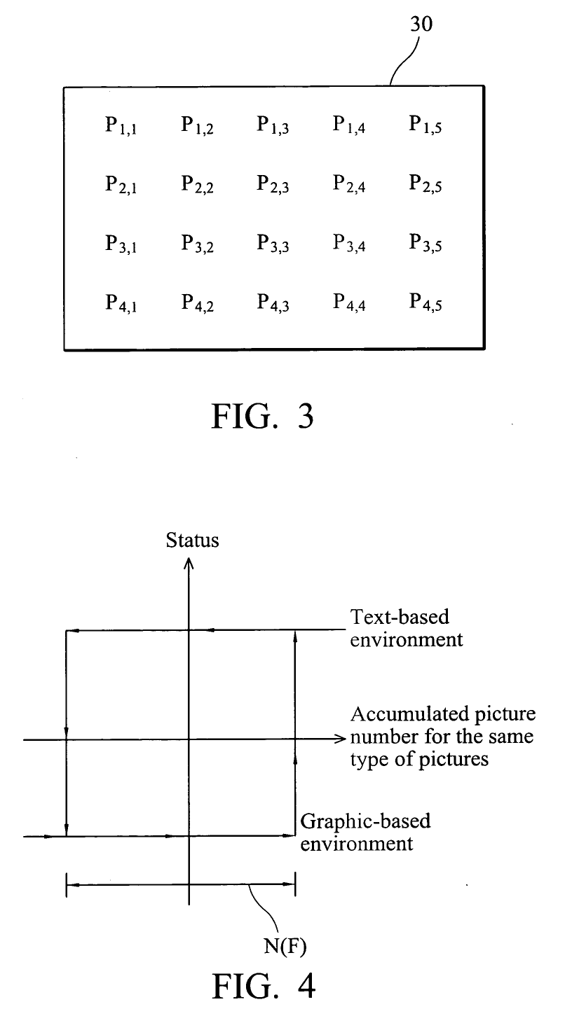

Details for processing of a picture are further described as follows. FIG. 3 is a diagram of an exemplary picture 30 with a resolution 5×4. The buffer 221 first acquires luminance data of pixels in the first row (P_{1, 1} to P_{1, 5}), the second row (P_{2, 1} to P_{2, 5}) and the third row (P_{3, 1} to P_{3, 5}) in the picture 30, and transmits the acquired data to the edge detection module 231. The edge detection module 231 first detects P_{1, 1} to P_{1, 3}, P_{2, 1} to P_{2, 3} and P_{3, 1} to P_{3, 3} to determine whether pixel P_{2, 2} is an edge pixel using formulae 6 and 7, and a predetermined threshold. The edge detection module 231 subsequently detects P_{1, 2} to P_{1, 4}, P_{2, 2} to P_{2, 4} and P_{3, 2} to P_{3, 4} to determine whether pixel P_{2, 3} is an edge pixel. The edge detection module 231 finally detects P_{1, 3} to P_{1, 5}, P_{2, 3} to P_{2, 5} and P_{3, 3} to P_{3, 5} to determine whether pixel P_{2, 4} is an edge pixel. When relevant pixels in the first to third rows in the picture 30 are completely detected, the buffer 221 transmits luminance data of pixels in the second row (P_{2, 1} to P_{2, 5}), the third row (P_{3, 1} to P_{3, 5}) and the fourth row (P_{4, 1} to P_{4, 5}) in the picture 30 to the edge detection module 231, and the edge detection module 231 determines whether pixels P_{3, 2}, P_{3, 3} and P_{3, 4} are edge pixels.

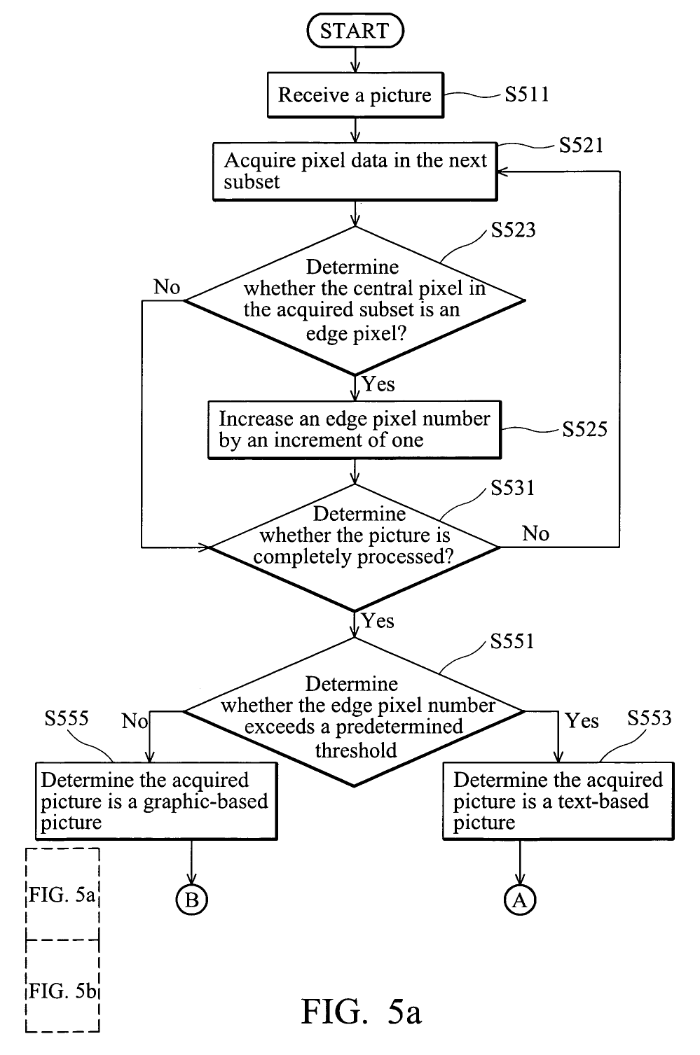

The status modification module 233 repeatedly receives determination results from the edge detection module 21, and determines whether a display adjustment signal Sₛₜₐₜᵤₛ is output by comparing current status with the determination results. The display adjustment signal Sₛₜₐₜᵤₛ is utilized to direct the scalar IC 15 to adjust display parameters for a text-based or graphic-based environment. When the display adjustment signal Sₛₜₐₜᵤₛ indicates an adjustment to a text-based environment (e.g. Sₛₜₐₜᵤₛ=0), the scalar IC 15 accordingly adjusts display parameters to fit text-based pictures, by for example, sharpening colors, improving contrast or slowing liquid crystal response time. Conversely, when the display adjustment signal Sₛₜₐₜᵤₛ indicates an adjustment to a graphic-based environment (e.g. Sₛₜₐₜᵤₛ=1) the scalar IC 15 accordingly adjusts display parameters to fit graphic-based pictures, by for example, smoothening colors, decreasing contrast or increasing liquid crystal response time. In order to avoid mis-adjustment, the status modification module 233 preferably employs the hysteresis mechanism to determine whether a display adjustment signal Sₛₜₐₜᵤₛ is output. FIG. 4 is a diagram of an embodiment of a hysteresis mechanism for environment adjustment. Specifically, when the status modification module 233 repeatedly receives a number of picture determinations different from the current status, such as N(F)=60, a relevant display adjustment signal Sₛₜₐₜᵤₛ is output. For example, when the current status is set to graphic-based environment and 60 text-based picture determinations are repeatedly received, the status modification module 233 outputs a display adjustment signal Sₛₜₐₜᵤₛ=0.

Note that, if circuit cost of the edge detection module 231 is not taken into account, the signal conversion module 211 may be omitted and the edge detection module 231 may perform edge pixel detection directly using RGB data of pixels in pictures, and alternatively, the edge detection module 231 may perform edge pixel detection both using luminance and chrominance data. If detection efficiency is not taken into account, the buffer 221 may be omitted.

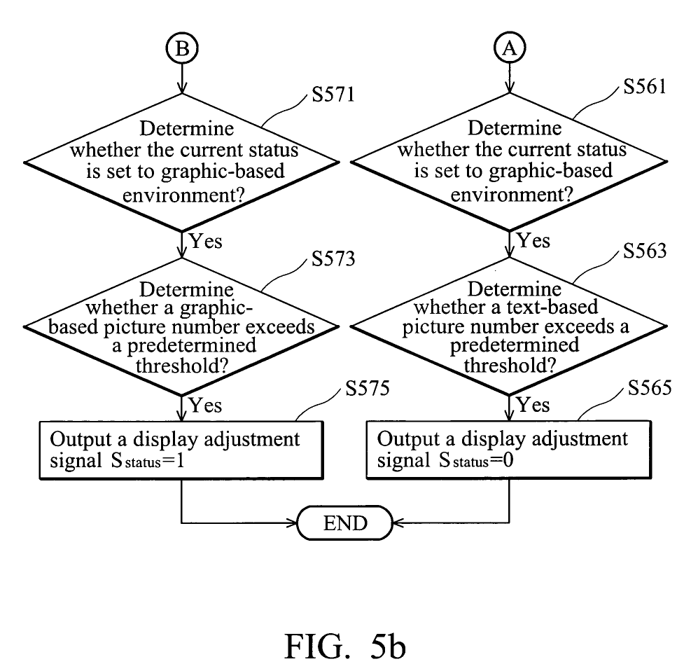

FIG. 5 is a flowchart of an embodiment of a method for display adjustment contingent upon picture content. The process begins in step S511, a picture is received. In step S521, pixel data in the next subset P_{c×c} is acquired, wherein, c represents a constant value (preferably is 3). Note that, if it is the first time to acquire pixel data in a picture, the upper-left subset P_{c×c} in a picture is acquired. Preferably, RGB data of pixels is converted into luminance data Y_{m×c} using formula 1 to 3 for further analysis. In step S523, it is determined whether the central pixel in the acquired subset is an edge pixel, and, if so, the process proceeds to step S525, and otherwise, to step S531. Edge pixels are pixels having pixel data with dissimilar color or luminance from adjacent pixels. Pixel data D_{c×c} in subset P_{c×c} is first acquired and calculated with a predetermined mask M_{c×c} to acquire a pixel difference Diff_{d}, and subsequently, it is determined whether the pixel difference exceeds a threshold, and, if so, the central pixel in the subset P_{c×c} is an edge pixel, and otherwise, is not an edge pixel. The mask M_{c×c} may be represented by formula 5, preferably, represented by formula 7 or 8. Formula 9 shows pixel data D_{c×c} in subset P_{c×c}:

$${D}_{c ⨯ c} = [ \begin{matrix}{D}_{1 , 1} & {D}_{1 , 2} & ⋯ & {D}_{1 , c - 1} & {D}_{1 , c} \\ {D}_{2 , 1} & {D}_{2 , 2} & ⋯ & {D}_{2 , c - 1} & {D}_{2 , c} \\ ⋮ & ⋮ & ⋮ & ⋮ & ⋮ \\ {D}_{c - 1 , 1} & {D}_{c - 1 , 2} & ⋯ & {D}_{c - 1 , c - 1} & {D}_{c - 1 , c} \\ {D}_{c , 1} & {D}_{c , 2} & ⋯ & {D}_{c , c - 1} & {D}_{c , c}\end{matrix} ] . \qquad ( 9 )$$

Formula 10 calculates a pixel difference Diff_{d}:

$${Diff}_{d} = {\sum }_{i = 1 toc ; j = 1 toc} D ( i , j ) * M ( i , j ) \qquad ( 10 )$$

In step S525, an edge pixel number is increased by an increment of one. In step S531, it is determined whether the picture is completely processed, and, if so, the process proceeds to step S551, and otherwise, to step S521. It may be achieved by determining whether the acquired subset is in the lower-right region.

In step S551, it is determined whether the edge pixel number exceeds a predetermined threshold, and, if so, the process proceeds step S553, and otherwise, to step S555. In step S553, the acquired picture is determined to be a text-based picture and a text-based picture number is increased by an increment of one. In step S561, it is determined whether the current status is set to a graphic-based environment, and, if so, the process proceeds to step S563. In step S563, it is determined whether the text-based picture number exceeds a predetermined threshold preferably being a value between 30 and 90, and, if so, the process proceeds to step S565. In step S565, a display adjustment signal Sₛₜₐₜᵤₛ=0 indicating an adjustment to a text-based environment is output.

In step S555, the acquired picture is determined to be a graphic-based picture and a graphic-based picture number is increased by an increment of one. In step S571, it is determined whether the current status is set to text-based environment, and, if so, the process proceeds to step S573. In step S573, it is determined whether the graphic-based picture number exceeds a predetermined threshold preferably being a value between 30 and 90, and, if so, the process proceeds to step S575. In step S575, a display adjustment signal Sₛₜₐₜᵤₛ=1 indicating an adjustment to a graphic-based environment is output.

When the display adjustment signal Sₛₜₐₜᵤₛ indicates an adjustment to a text-based environment (e.g. Sₛₜₐₜᵤₛ=0), the display apparatus accordingly adjusts display parameters to fit text-based pictures, by for example, sharpening colors, improving contrast or slowing liquid crystal response time. Conversely, when the display adjustment signal Sₛₜₐₜᵤₛ indicates an adjustment to a graphic-based environment (e.g. Sₛₜₐₜᵤₛ=1) the display apparatus accordingly adjusts display parameters to fit graphic-based pictures, by for example, smoothening colors, decreasing contrast or increasing liquid crystal response time.

While the invention has been described in terms of preferred embodiment, it is not intended to limit the invention thereto. Those skilled in this technology can still make various alterations and modifications without departing from the scope and spirit of this invention. Therefore, the scope of the invention shall be defined and protected by the following claims and their equivalents.

What is claimed is:

1. A method for display parameter adjustment contingent upon display content, performed by a display apparatus, the method comprising:
acquiring pixel data in a picture;
calculating an edge pixel number using the received pixel data in the picture;
determining whether the picture is a text-based picture or a graphic-based picture,
wherein the edge pixel number represents how many pixels have pixel data with dissimilar color or luminance from adjacent pixels.

2. The method as claimed in claim 1 wherein the pixel data in the picture is RGB data.

3. The method as claimed in claim 1 wherein the pixel data in the picture is luminance data.

4. The method as claimed in claim 3 further comprising converting RGB data into the luminance data.

5. The method as claimed in claim 1 further comprising outputting a display adjustment signal when the determination result for the picture does not correspond to the current display environment, enabling adjustment of a display parameter contingent upon the display adjustment signal.

6. The method as claimed in claim 5 wherein the step of determining whether the picture is a text-based picture or a graphic-based picture further comprises:
determining the picture is a text-based picture when the edge pixel number exceeds a quantity threshold; and
determining the picture is a graphic-based picture when the edge pixel number is lower the quantity threshold.

7. The method as claimed in claim 5 wherein a plurality of fixed-size subsets are extracted from the picture, any two of the subsets are mutually independent or partially overlapping, and pixel data in each subset is represented as:
$${D}_{c ⨯ c} = [ \begin{matrix}{D}_{1 , 1} & {D}_{1 , 2} & ⋯ & {D}_{1 , c - 1} & {D}_{1 , c} \\ {D}_{2 , 1} & {D}_{2 , 2} & ⋯ & {D}_{2 , c - 1} & {D}_{2 , c} \\ ⋮ & ⋮ & ⋮ & ⋮ & ⋮ \\ {D}_{c - 1 , 1} & {D}_{c - 1 , 2} & ⋯ & {D}_{c - 1 , c - 1} & {D}_{c - 1 , c} \\ {D}_{c , 1} & {D}_{c , 2} & ⋯ & {D}_{c , c - 1} & {D}_{c , c}\end{matrix} ] ,$$
where c represents a predetermined constant.

8. The method as claimed in claim 7 wherein the step of calculating the edge pixel number further comprises:
acquiring a pixel difference by calculating the pixel data in each subset with a mask matrix;
determining whether the pixel difference exceeds a difference threshold; and
if the pixel difference exceeds the difference threshold, determining that the central pixel in the subset is an edge pixel, and accordingly updating the edge pixel number.

9. The method as claimed in claim 8 wherein the mask matrix is represented as:
$${M}_{c ⨯ c} = [ \begin{matrix}{M}_{1 , 1} & {M}_{1 , 2} & ⋯ & {M}_{1 , c - 1} & {M}_{1 , c} \\ {M}_{2 , 1} & {M}_{2 , 2} & ⋯ & {M}_{2 , c - 1} & {M}_{2 , c} \\ ⋮ & ⋮ & ⋮ & ⋮ & ⋮ \\ {M}_{c - 1 , 1} & {M}_{c - 1 , 2} & ⋯ & {M}_{c - 1 , c - 1} & {M}_{c - 1 , c} \\ {M}_{c , 1} & {M}_{c , 2} & ⋯ & {M}_{c , c - 1} & {M}_{c , c}\end{matrix} ] ,$$
and
the pixel difference is calculated by
$${Diff}_{d} = {\sum }_{i = 1 toc ; j = 1 toc} D ( i , j ) * M ( i , j ) ,$$
where d representing the central pixel in each subset.

10. The method as claimed in claim 9 wherein c equals 3, and the mask matrix is represented as:
$${M}_{3 ⨯ 3} = [ \begin{matrix}0 & 1 & 0 \\ 1 & - 4 & 1 \\ 0 & 1 & 0\end{matrix} ] .$$

11. The method as claimed in claim 5 wherein the step of outputting the display adjustment signal further comprises:
acquiring an accumulated picture number corresponding to the determined result of the picture;
determining whether the accumulated picture number exceeds an accumulation threshold; and
outputting the display adjustment signal when the accumulated picture number exceeds the accumulation threshold.

12. A display apparatus for display parameter adjustment contingent upon display content, comprising:
an edge detection module acquiring pixel data in a picture, calculating an edge pixel number using the received pixel data in the picture and determining whether the picture is a text-based picture or a graphic-based picture,
wherein the edge pixel number represents how many pixels have pixel data with dissimilar color or luminance from adjacent pixels.

13. The display apparatus as claimed in claim 12 wherein the pixel data in the picture is RGB data.

14. The display apparatus as claimed in claim 12 wherein the pixel data in the picture is luminance data.

15. The display apparatus as claimed in claim 12 further comprising a status modification module coupling to the edge detection module and outputting a display adjustment signal when the determination result for the picture does not correspond to the current display environment, enabling to adjust a display parameter contingent upon the display adjustment signal.

16. The display apparatus as claimed in claim 15 wherein the edge detection module further determines the picture is text-based picture when the edge pixel number exceeds a quantity threshold, and determines that the picture is a graphic-based picture when the edge pixel number is lower the quantity threshold.

17. The display apparatus as claimed in claim 15 wherein a plurality of fixed-size subsets are extracted from the picture, any two of the subsets are mutually independent or partially overlapping, and pixel data in each subset is represented as:
$${D}_{c ⨯ c} = [ \begin{matrix}{D}_{1 , 1} & {D}_{1 , 2} & ⋯ & {D}_{1 , c - 1} & {D}_{1 , c} \\ {D}_{2 , 1} & {D}_{2 , 2} & ⋯ & {D}_{2 , c - 1} & {D}_{2 , c} \\ ⋮ & ⋮ & ⋮ & ⋮ & ⋮ \\ {D}_{c - 1 , 1} & {D}_{c - 1 , 2} & ⋯ & {D}_{c - 1 , c - 1} & {D}_{c - 1 , c} \\ {D}_{c , 1} & {D}_{c , 2} & ⋯ & {D}_{c , c - 1} & {D}_{c , c}\end{matrix} ] ,$$
where c represents a predetermined constant.

18. The display apparatus as claimed in claim 17 wherein the edge detection module further acquires a pixel difference by calculating the pixel data in each subset with a mask matrix, determines whether the pixel difference exceeds a difference threshold, and, if so, determines that the central pixel in the subset is an edge pixel, and accordingly updates the edge pixel number.

19. The display apparatus as claimed in claim 18 wherein the mask matrix is represented as:
$${M}_{c ⨯ c} = [ \begin{matrix}{M}_{1 , 1} & {M}_{1 , 2} & ⋯ & {M}_{1 , c - 1} & {M}_{1 , c} \\ {M}_{2 , 1} & {M}_{2 , 2} & ⋯ & {M}_{2 , c - 1} & {M}_{2 , c} \\ ⋮ & ⋮ & ⋮ & ⋮ & ⋮ \\ {M}_{c - 1 , 1} & {M}_{c - 1 , 2} & ⋯ & {M}_{c - 1 , c - 1} & {M}_{c - 1 , c} \\ {M}_{c , 1} & {M}_{c , 2} & ⋯ & {M}_{c , c - 1} & {M}_{c , c}\end{matrix} ] ,$$
and
the pixel difference is calculated by
$${Diff}_{d} = {\sum }_{i = 1 toc ; j = 1 toc} D ( i , j ) * M ( i , j ) ,$$
where d representing the central pixel in each subset.

20. The display apparatus as claimed in claim 15 wherein the status modification module further acquires an accumulated picture number corresponding to the determined result of the picture, determines whether the accumulated picture number exceeds an accumulation threshold, and outputs the display adjustment signal when the accumulated picture number exceeds the accumulation threshold.
